(19) United States
(12) Patent Application Publication
(10) Pub. No.: US 2025/0034455 A1
(43) Pub. Date: Jan. 30, 2025

(54) DISPERSION OF COMPLEX SCALE BASED ON ELEMENTAL SULFUR IN ACIDIC WATER

(71) Applicant: SOLENIS TECHNOLOGIES, L.P., Wilmington, DE (US)

(72) Inventors: Kirill N. Bakeev, Newark, DE (US); Derek Kline, Wilmington, DE (US); Corinne E. Carrido, Wilmington, DE (US)

(73) Assignee: SOLENIS TECHNOLOGIES, L.P., Wilmington, DE (US)

(21) Appl. No.: 18/785,055

(22) Filed: Jul. 26, 2024

Related U.S. Application Data
(60) Provisional application No. 63/515,927, filed on Jul. 27, 2023.

(51) Int. Cl. C09K 23/12; C09K 23/50

(52) U.S. Cl. CPC C09K 23/12; C09K 23/50

(57) ABSTRACT

Compositions and methods for dispersing complex scale based on elemental sulfur are provided. A method for dispersing elemental sulfur in acidic water includes providing water including elemental sulfur and adding from about 1 to about 100 parts by weight of a sulfur dispersion additive to the water based on one million parts by weight of the water to disperse the elemental sulfur in the water. The sulfur dispersion additive is chosen from a water soluble aromatic surfactant, a lignosulfonate, a naphthalene sulfonate, and combinations thereof.

### CROSS-REFERENCE TO RELATED APPLICATION

This application claims the benefit of U.S. Provisional Application No. 63/515,927, filed Jul. 27, 2023, and U.S. Provisional Application No. 63/620,929, filed Jan. 15, 2024, both of which are hereby incorporated in its entirety by reference.

### TECHNICAL FIELD

The present disclosure generally relates to a method for dispersing elemental sulfur, as part of more complex scale, in acidic water. More specifically, this disclosure relates to adding a particular dispersion additive to acidic water that includes elemental sulfur so as to disperse the sulfur in the water.

### BACKGROUND

The problem of solid mineral deposits in the extraction industry is substantial and costly. Geothermal, gas and oil, and mining processing fluids all can carry potential insolubles related to elemental sulfur as part of more complex insolubles composition. During fluid phase processing, the insoluble may form solid deposits on processing equipment, such as on scrubber vessel surfaces, transfer piping, pumps, and the like, including during continuous production processes. These deposits reduce efficiency and require periodic system shutdowns of continuous production processing, resulting in the loss of production, increased costs, and reduced profitability. When examined, the deposits from the certain copper extraction mining processing fluids contain elemental sulfur and jarosite, among other materials.

Mechanical cleaning requires a system shutdown and labor-intensive removal of deposits. Keeping the sulfur suspended and/or re-dispersing deposited sulfur solids allows for the in situ treatment of the issue without a costly shut-down. However, certain solvents may not be appropriate for downstream processing. Also, certain solvents have a high cost and requirements to recycle the solvent prevents widespread application.

Minimization and prevention of deposition of elemental sulfur in extraction systems still requires an effective, inexpensive, and environmentally responsible solution for in situ treatment. In addition, the treatment should be substantially low in foaming, non-corrosive, and not interfere with other components of the water treatment operation. Therefore, there remains an opportunity for improvement. Furthermore, other desirable features and characteristics of the present disclosure will become apparent from the subsequent detailed description of the disclosure and the appended claims, taken in conjunction with this background of the disclosure.

### BRIEF SUMMARY

This summary is provided to introduce a selection of concepts in a simplified form that are further described below in the detailed description section.

A method for dispersing complex scale based on elemental sulfur in acidic water includes providing acidic water comprising elemental sulfur; and adding from about 1 to about 100 parts by weight of a sulfur dispersion additive to the water based on one million parts by weight of the water to disperse the elemental sulfur in the water, wherein the sulfur dispersion additive is chosen from: a water-soluble aromatic surfactant, a lignosulfonate, a naphthalene sulfonate, and combinations thereof.

A sulfur dispersing composition includes acidic water; elemental sulfur; and a sulfur dispersion additive chosen from: a water soluble aromatic surfactant, a lignosulfonate, a naphthalene sulfonate, and combinations thereof, wherein the sulfur dispersion additive is present in an amount of from about 1 to about 100 parts by weight per one million parts by weight of the composition.

Other desirable features will become apparent from the following detailed description and the appended claims, taken in conjunction with the technical field, brief summary, and background.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the systems and methods defined by the claims. Furthermore, there is no intention to be bound by any expressed or implied theory presented in the preceding Technical Field, Background, Brief Summary or the following Detailed Description.

As used herein, “a,” “an,” or “the” means one or more unless otherwise specified. The term “or” can be conjunctive or disjunctive. Open terms such as “include,” “including,” “contain,” “containing” and the like mean “comprising.” The term “about” as used in connection with a numerical value throughout the specification and the claims denotes an interval of accuracy, familiar and acceptable to a person skilled in the art. In general, such interval of accuracy is ±ten percent. Thus, “about ten” means nine to eleven. All numbers in this description indicating amounts, ratios of materials, physical properties of materials, and/or use are to be understood as modified by the word “about,” except as otherwise explicitly indicated. As used herein, the “%” described in the present disclosure refers to the weight percentage unless otherwise indicated.

Embodiments of the present disclosure are generally directed to a method for dispersing elemental sulfur in water and a composition for the same. For the sake of brevity, conventional techniques may not be described in detail herein. Moreover, the various tasks and process steps described herein may be incorporated into a more comprehensive procedure or process having additional steps or functionality not described in detail herein. In particular, various steps in the manufacture of components of the composition may be well-known and so, in the interest of brevity, many conventional steps will only be mentioned briefly herein or will be omitted entirely without providing the well-known process details.

This disclosure provides a method for dispersing elemental sulfur in water. Typically, the water is acidic. For example, the water may have a pH of less than 7, such as less than 6.5, less than 6, less than 5.5, less than 5, less than 4.5, less than 4, less than 3.5, less than 3, less than 2.5, less than 2, less than 1.5, or less than 1. Further, the water may have a pH of at least 0.5, at least 1, at least 1.5, at least 2, at least 2.5, at least 3, at least 3.5, at least 4, at least 4.5, at least 5, at least 5.5, at least 6, or at least 6.5.

The amount of sulfur in the water is not particularly limited and may be any amount, e.g. any amount found in water used in mineral extraction, geothermal, natural gas, oil, fracking, and power generation industries. In various embodiments, the amount of sulfur in the water is no greater than 100, 80, 60, 50, 40, 30, 20, 10, 8, 6, 5, 4, 3, 2, 1, 0.5, or 0.1 parts by weight per one million parts by weight of the water.

It is desirable to disperse the elemental sulfur in the water so as to reduce the chance that the elemental sulfur can stick to machinery used in the aforementioned industries. For example, elemental sulfur can contribute to solid deposits on scrubber surfaces, heat exchanger surfaces, cooling tower fill, and within fluid transfer pipes which reduces heat transfer efficiency, clogs nozzles, and requires periodic system shutdowns, resulting in the loss of efficiency, increased costs, and reduced profitability.

The terminology “dispersing” typically describes that the elemental sulfur is wetted and solid particles of the elemental sulfur are dispersed in the water. Typically, if the elemental sulfur floats on the top of the water or sinks to the bottom of a container, such as a test tube, the sulfur is not considered to be dispersed. The determination of whether the elemental sulfur is dispersed in the water may be made based on turbidity or optical density of the water, as is described in greater detail below. For example, if the elemental sulfur either floats on the top of the water or sinks to the bottom, the turbidity or optical density of the water may not be affected, thus signaling that the elemental sulfur is not dispersed. If the elemental sulfur floats on the top of the water, this generally indicates that the elemental sulfur is not wetted by a sulfur dispersion additive, as is described below. If the elemental sulfur is not wetted, then it is more likely to be available to stick to machinery and contribute to unwanted deposits thereon. If the elemental sulfur drops to the bottom of the water, the elemental sulfur may also still contribute to the unwanted deposits.

The method includes the step of providing water including the elemental sulfur. The water may also include, or be free of, many other compounds including, but not limited to, iron-hydroxysulfate minerals, jarosite, natrojarosite, anhydrite, iron sulfates, alunogen, cristobalite, hydrogen sulfide, polysulfides, metal sulfides, and any compounds known by those of skill in the art to typically be found in water used in mineral extraction, geothermal, natural gas, oil, fracking, and power generation industries. In some embodiments, the water and/or the combination of the water and the sulfur dispersion additive may include less than about 50, 45, 40, 35, 30, 25, 20, 15, 10, 5, 1, 0.5, 0.1, 0.05, or 0.01 wt % of any one or more optional additives or compounds described herein. In some embodiments, the water and/or the combination of the water and the sulfur dispersion additive may include more than about 0.01, 0.05, 0.1, 0.5, 1, 5, 10, 15, 20, 25, 30, 35, 40, or 45 wt % of any one or more optional additives or compounds described herein. In some embodiments, the water and/or the combination of the water and the sulfur dispersion additive may be free of any one or more optional additives or compounds described herein. In some embodiments, the water and/or the combination of the water and the sulfur dispersion additive may be substantially free of any one or more optional additives or compounds described herein.

Scale from field testing has been found to include from 15 to 70% sulfur, 5 to 60% jarosite, 0 to 5% millosevichite, 0 to 5% natrojarosite, 0 to 5% anhydrite, 0 to 5% Fe(S04)(OH), 0 to 5% alunogen, 0 to 5% cristobalite, and 0 to 50% amorphous material. Thus, field process fluid may include such compounds in same or similar ratios. For example, the total amount of scale-forming material may include 15 to 70% sulfur, such as at least 15, 20, 25, 30, 35, 40, 45, 50, 55, 60 or 65% sulfur, and at most 70, 65, 60, 55, 50, 45, 40, 35, 30, 25, or 20% sulfur.

As used herein, water and/or the combination of the water and the sulfur dispersion additive that is “substantially free” of delineated materials, i.e., compounds or elements, may be completely free of the delineated materials or may contain less than the detectable level of the delineated materials. In certain embodiments, water and/or the combination of the water and the sulfur dispersion additive that is “substantially free” of delineated material, may include less than 1 mol percent of the delineated material in relation to the total content.

In certain embodiments, the water and/or the combination of the water and the sulfur dispersion additive is provided at a temperature of from ambient temperature to 150° C. For example, the water and/or the combination of the water and the sulfur dispersion additive may be provided at a temperature of at least 30° C., 40° C., 50° C., 60° C., 70° C., 80° C., 90° C., 1000 C, 110° C., 120° C., 130° C., or 140° C. Further, the water and/or the combination of the water and the sulfur dispersion additive may be provided at a temperature of at most 40° C., 50° C., 60° C., 70° C., 80° C., 90° C., 100° C., 110° C., 120° C., 130° C., 140° C. or 150° C.

The method also includes the step of adding from about 1 to about 100 parts by weight of the sulfur dispersion additive to the water based on one million parts by weight of the water to disperse the elemental sulfur in the water. In various embodiments, at least 1, at least 2, at least 3, at least 4, at least 5, at least 6, at least 7, at least 8, at least 9, at least 10, at least 12, at least 15, at least 20, at least 25, at least 30, at least 35, at least 40, at least 45, at least 50, at least 55, at least 60, at least 65, at least 70, at least 75, at least 80, at least 85, at least 90, or at least 95 parts by weight of the sulfur dispersion additive is added to the water based on one million parts by weight of the water to disperse the elemental sulfur in the water. In various embodiments, at most 100, at most 95, at most 90, at most 85, at most 80, at most 75, at most 70, at most 65, at most 60, at most 55, at most 50, at most 45, at most 40, at most 35, at most 30, at most 25, at most 20, at most 15, at most 14, at most 13, at most 12, at most 11, at most 10, at most 9, at most 8, at most 7, at most 6, at most 5, at most 4, at most 3, at most 2, or at most 1 parts by weight of the sulfur dispersion additive is added to the water based on one million parts by weight of the water to disperse the elemental sulfur in the water. In various non-limiting embodiments, all values and ranges of values including and between those set forth above are hereby expressly contemplated for use.

### Sulfur Dispersion Additive

Typically, the sulfur dispersion additive, i.e., agent for dispersing sulfer, is chosen from a water-soluble surfactant having an aromatic motif, a lignosulfonate, a naphthalene sulfonate, and combinations thereof. These compounds, as a genus, are not particularly limited and specific compounds used herein may be any species that falls within its related genus, as would be understood by one of skill in the art.

### Water-Soluble Surfactant

In some embodiments, the sulfur dispersion additive is or includes a water-soluble surfactant having an aromatic motif. A suitable surfactant has at least two aromatic rings.

In some embodiments, the sulfur dispersion additive is or includes a water-soluble surfactant having a bi-phenyl aromatic structure.

In some embodiments, the surfactant is synthetic and may include well-defined polar and non-polar portions.

In some embodiments, the water-soluble surfactant has low molecular weight. For example, the water-soluble surfactant has a molecular weight of less than 5000, such as less than 4500, 4000, 3500, 3000, 2500, 2000, 1500, 1000, 900, 800, 700, 600, 500, 400, 300, or 200 grams/mol.

In some embodiments, the surfactant may be an alkyldiphenyloxide disulfonate or salt thereof. The alkyldiphenyloxide disulfonate or salt thereof may be any known in the art and typically has the following structure:

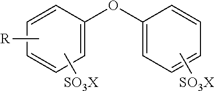

wherein R is an alkyl group having from 1 to 35 carbon atoms and each X is independently a cation. The alkyl group may be linear, branch, or cyclic. Moreover, the cation may be any that balance a (−1) negative charge on the sulfate anion. Typically, the cation is a (+1) cation such as Na+1, K+1, etc. However, any other inorganic cation may be used. Alternatively, any organic (+1) cation may also be used. In various embodiments, R is an alkyl group having from 5 to 35, 10 to 30, 15 to 25, 15 to 20, 1, 2, 3, 4, 5, 6, 7, 8, 9, 10, 11, 12, 13, 14, 15, 16, 17, or 18, carbon atoms. In other embodiments, R is an alkyl group having from 6 to 18, 8 to 16, 10 to 14, 10 to 12, 12 to 14, 12 to 16, 12 to 18, 10 to 16, 10 to 18, 8 to 18, 8 to 16, 8 to 14, 8 to 12, 8 to 10, 30 to 34, 30 to 32, 32 to 34, 28 to 24, 28 to 32, or 28 to 30, carbon atoms. In another embodiment, R is an alkyl group having 6, 10, or 12 carbon atoms. In one embodiment, R is an alkyl group having 10 to 14 carbon atoms and X is Na+. In another embodiment, R is an alkyl group having 12 carbon atoms and X is Na+. In a further embodiment, R is an alkyl group having 30 to 32 carbon atoms and X is Na+. In various non-limiting embodiments, all values and ranges of values including and between those set forth above are hereby expressly contemplated for use.

In various embodiments, suitable alkyldiphenyloxide disulfonates or salts thereof are contained in commercially available products from Dow Chemical under the tradenames of DOWFAX™ 2A1, DOWFAX™ 3B2, DOWFAX™ 8390; DOWFAX™ C6L, DOWFAX™ C10L, DOWFAX™ 30599, and the like. In other embodiments, suitable alkyldiphenyloxide disulfonates or salts thereof are contained in commercially available products from Pilot Chemical under the tradenames of Calfax L-45, Calfax 16L-35, Calfax 6LA-70, Calfax DB-45, Calfax DBA-40, Calfax DBA-70, and the like. All amounts set forth above for content of the sulfur dispersion additive are based on active content of any commercial product mentioned herein.

In some embodiments, the surfactant may be an isododecyl hydrophobe, such as a branched C12; a linear C10 hydrophobe; a linear hexyl hydrophobe; a Di-2-ethylhexyl sodium sulfosuccinate; a Dioctyl sodium sulfosuccinate; a C12 (Linear) Sodium Diphenyl Oxide Disulfonate; an Octylphenol polyethoxyethanol; or a sodium dodecylbenzene sulfonate.

Suitable surfactants may be contained in Aerosol® OT-70 PG Surfactant commercially available from Solvay Novecare, and TRITON™ GR-7M and TRITON™ X-100 commercially available from Dow Chemical.

In some embodiments, the sulfur dispersion additive is or includes a water-soluble surfactant that is hydrophobic. For example, the water-soluble surfactant may have a hydrophobicity indicated by static water contact angle values, measured on a smooth and plane surface of a film formed from the surfactant, that are higher than 90°. For example, the water-soluble surfactant may have a contact angle measurement of at least 90°, at least 100°, at least 110°, at least 120°, at least 130°, at least 140°, at least 150°, or at least 160°.

### Lignosulfonate

In some embodiments, the sulfur dispersion additive is or includes a lignosulfonate.

In some embodiments, the lignosulfonate is a sodium lignosulfonate or an ammonium lignosulfonate.

In some embodiments, the lignosulfonate is natural, i.e., non-synthetic, and does not include well-defined polar and non-polar portions.

In some embodiments, the lignosulfonate has a high molecular weight. For example, the lignosulfonate has a molecular weight of greater than 5000, such as greater than 6000, 7000, 8000, 9000, 10000, 12000, 14000, 16000, 18000, 20000, or 250000 grams/mol.

In certain embodiments, the lignosulfonate is provided in a product having a low sugar impurity content, such as a sugar impurity content of no more than 25%, 20%, 18%, 16%, 14%, 12%, 10%, 9.5%, 9%, 8.5%, 8%, 7.5%, 7%, 6.5%, 6%, 5.5%, 5%, 4.5%, 4%, 3.5%, 3%, 2.5%, 2%, 1.5%, 1%, 0.5%, or 0.1%, as measured by High-Performance Liquid Chromatography (HPLC).

In certain embodiments, the lignosulfonate is provided in a product having a high sulfonated charge. In certain embodiments, the lignosulfonate is provided in a product having a sulfur content of no more than 20%, such as no more than 10%, 9%, 8%, 7%, or 6%. In certain embodiments, the lignosulfonate is provided in a product having a sulfur content of at least 5%, such as at least 5.2%, 5.4%, 5.6%, 5.8%, 6%, 6.2%, 6.4%, 6.6%, 6.8%, 7%, 7.2%, 7.4%, 7.6%, 7.8%, 8%, 8.2%, 8.4%, 8.6%, 8.8%, or 9%.

In certain embodiments, a lignosulfonate provided in a product having a low but relatively higher sugar impurity content may still perform satisfactorily if the sulfur content of the product is sufficiently high. Likewise, a lignosulfonate provided in a product having a high but relatively lower sulfur content may still perform satisfactorily if the sugar impurity content of the product is sufficiently low. Thus, a selected product including the lignosulfonate may have any sugar impurity content wihtin the range described above and any sulfur content within the range described above.

### Naphthalene Sulfonate

In some embodiments, the sulfur dispersion additive is or includes a naphthalene sulfonate. For example, a suitable naphthalene sulfonate may be contained in a product commercially available under the tradenames: Tamol™ NN9401 (naphthalene sulfonic acids compound sodium salt), Tamol™ SN (formaldehyde-napthalenesulfonic acid condensates sodium salt), and Tamol™ NN8906 (naphthalene sulfonate condensed with formaldehyde), all commercially available from Dow Chemical.

In some embodiments, the naphthalene sulfonate has a high molecular weight. For example, the naphthalene sulfonate has a molecular weight of greater than 5000, such as greater than 6000, 7000, 8000, 9000, 10000, 20000, or 250000 grams/mol.

### Dispersion Effect

The dispersion additive may be evaluated based on its dispersion effect on a sample as compared to a same sample that is not provided with a dispersion additive, i.e., a blank. The dispersion effect may be determined according to the equation:

$$\% Dispersion Effect = \frac{{Turbidity}_{current sample} - {Turbidity}_{current blank}}{{Turbidity}_{starting blank} - {Turbidity}_{current blank}} \times 100 \%$$

Turbidity may be measured in Nephelometric Turbidity Units (NTU). In an exemplary embodiment, the mixture formed by adding the dispersion additive to a sample of acidic water or process fluid has an improved turbidity that is at least 10 Nephelometric Turbidity Units (NTU) in excess of a turbidity of an untreated sample of the acidic water or process fluid comprising elemental sulfur without the sulfur dispersion additive. For example, the improved turbidity may be at least 10, at least 12.5, at least 15, at least 17.5, at least 20, at least 22.5, at least 25, at least 27.5 or at least 30 NTU in excess of the turbidity of an untreated sample of the acidic water or process fluid. Starting blanks are the blanks measured right after dosing the soluble sulfur in ethanol mixture into the jars. Current blanks and current samples are the samples analyzed after 16 hours.

### Settling Rate

The dispersion additive may be evaluated based on a settling rate of the dispersion of a sample as compared to a same sample that is not provided with a dispersion additive, i.e., a blank. More specifically, the two samples may be processed under same conditions to form dispersions. Then, the dispersions are optically monitored after various periods of time. Visible settling of solids is monitored, as well as the cloudiness of the dispersion itself.

### EXAMPLES

A series of compositions are created according to this disclosure and compared with a control composition to illustrate the effectiveness of the sulfur dispersion additives.

### Example 1

In Example 1, complex field scale, i.e., scale from a scrubber at a mineral extraction plant in North America, in field process water from the mineral extraction plant in North America was tested with various dispersion additives which include water-soluble surfactants.

Each sample was provided by:
adding 100 mL of the process water to an eight ounce glass jar with a stir bar;
preheating each jar in an oven at 85° C. for 1 hour in oven;
adding 25 mg of the scale to each jar placed on Scilogex SCI-S10 10-place analog stirrer, outside oven;-adding the selected amount of selected product to each respective jar;
mixing until full dispersion occurs;
measuring temperature;
measuring turbidity of liquid in each jar after 5 mins; and
calibrating measurement with respect to preheated solution without scale at a basis of 0 NTU.

TABLE 1

| | | | Amount | Calibrated | |
|---|---|---|---|---|---|
| Sample | | Additive | added | NTU | Average |
| 1A | 1 | — | — | 2.3 | 1.8 ± 0.4 |
| | 2 | — | — | 1.4 | |
| 1B | 1 | Dowfax 2A1 | 25 ppm | 6.3 | 11.3 ± 5.0 |
| | 2 | Dowfax 2A1 | 25 ppm | 16.3 | |
| 1C | 1 | Dowfax 2A1 | 100 ppm | 11.1 | 14.1 ± 2.9 |
| | 2 | Dowfax 2A1 | 100 ppm | 17.0 | |
| 1D | 1 | *BHMTPMPA/ | 25 ppm | 1.0 | 1.6 ± 0.6 |
| | | sodium hexametaphosphate | | | |
| | 2 | *BHMTPMPA/ | 25 ppm | 2.3 | |
| | | sodium hexametaphosphate | | | |
| 1E | 1 | *BHMTPMPA/ | 100 ppm | −0.2 | 4.1 ± 4.3 |
| | | sodium hexametaphosphate | | | |
| | 2 | *BHMTPMPA/ | 100 ppm | 8.3 | |
| | | sodium hexametaphosphate | | | |

*BHMTPMPA = [Bis[6-[bis(phosphonomethyl)amino]hexyl]amino]methylphosphonic acid

In Example 1, the temperature upon full dispersion was 48 C within five minutes.

### Example 2

In Example 2, elemental sulfur in field process water from the mineral extraction location plant in North America was tested with various dispersion additives which include water-soluble surfactants. Each sample was provided by:
adding 100 mL of the process water to an eight ounce glass jar with a stir bar;
preheating each jar in an oven at 85° C. for 1 hour in oven;
adding 25 mg of elemental sulfur to each jar placed on Scilogex SCI-S10 10-place analog stirrer, outside oven;
adding the selected amount of selected product to each respective jar;
mixing until full dispersion occurs;
measuring temperature;
measuring turbidity of liquid in each jar after 5 mins; and
calibrating measurement with respect ot preheated solution without scale at a basis of 0 NTU.

TABLE 2

| | | | Amount | Calibrated | |
|---|---|---|---|---|---|
| Sample | | Additive | added | NTU | Average |
| 2A | 1 | — | — | 1.5 | 1.5 ± 0.1 |
| | 2 | — | — | 1.6 | |
| 2B | 1 | Dowfax 2A1 | 25 ppm | 24.2 | 28.3 ± 4.1 |
| | 2 | Dowfax 2A1 | 25 ppm | 32.4 | |
| 2C | 1 | Dowfax 2A1 | 100 ppm | 25.9 | 23.1 ± 2.9 |
| | 2 | Dowfax 2A1 | 100 ppm | 20.2 | |
| 2D | 1 | *BHMTPMPA/ | 25 ppm | 2.1 | 1.3 ± 0.8 |
| | | sodium hexametaphosphate | | | |
| | 2 | *BHMTPMPA/ | 25 ppm | 0.6 | |
| | | sodium hexametaphosphate | | | |
| 2E | 1 | *BHMTPMPA/ | 100 ppm | 2.6 | 2.7 ± 0.1 |
| | | sodium hexametaphosphate | | | |
| | 2 | *BHMTPMPA/ | 100 ppm | 2.8 | |
| | | sodium hexametaphosphate | | | |

*BHMTPMPA = [Bis[6-[bis(phosphonomethyl)amino]hexyl]amino]methylphosphonic acid

### Example 3

In Example 3, elemental sulfur in acidic water prepared from DI water and HCl was tested with various dispersion additives which are or include water-soluble surfactants.

Testing was performed according to the following protocol. A stock solution was prepared with 4 mL of HCL in 2 L of deionized (DI) water to obtain a pH of from 1.8 to 2. Each product stock solution was prepared with 1.04 g of the product in DI water, filled to 100 mL. Ethanol (EtOH) stock solutions were prepared with 0.06 g of elemental S in 200 proof EtOH, and filled to 100 mL.

For testing of each product, first, 100 mL of acidic water in 8 oz jars in shaker set IKA KS 4000i Control shaker were preheated to 70° C. for one hour while shaking at 180 rpm. The second step was adding the desired amount of the desired product in jars. Third, 4 mL of the EtOH solution was added to all jars. Blanks were recorded after 5-15 minutes of shaking at 70° C. and 180 rpm. Then, percent dispersion of elemental sulfur for each sample was measured by recording final turbidity of all results after shaking for 16 hours.

TABLE 3

| | | | | Elemental Sulfur Dispersion | | | | |
|---|---|---|---|---|---|---|---|---|
| | Brand | Chemistry type | Total solids | 30 ppm | 20 ppm | 10 ppm | 5 ppm | 3 ppm |
| 3A | Dowfax 2A1 | isododecyl hydrophobe | 48.46% | 100.0% | 99.4% | 100% | 78.6% | 77.5% |
| | | (branched C12) | | | | | | |
| 3B | Dowfax 3B2 | linear C10 hydrophobe | 48.38% | — | — | — | 85.0% | 84.8% |
| 3C | Dowfax C6L | linear hexyl hydrophobe | 48.21% | 100.0% | 100.0% | 95.3% | 28.0% | 5.4% |
| 3D | TRITON ™ | Di-2-ethylhexyl sodium | 63.03% | 100% | — | — | — | — |
| | GR-7M | sulfosuccinate (65%) in | | | | | | |
| | | naphtha | | | | | | |
| 3E | Aerosol OT | Dioctyl sodium | 68.8% | 61.6% | — | — | — | — |
| | 70PG | sulfosuccinate in | | | | | | |
| | | propylene glycol | | | | | | |
| 3F | Calfax DB- | C12 (Linear) Sodium | 51.33% | 100% | 100% | 100% | 75.4% | 75.8% |
| | 45 | Diphenyl Oxide | | | | | | |
| | | Disulfonate | | | | | | |

### Example 4

In Example 4, elemental sulfur in acidic water prepared from DI water and HCl was tested with various dispersion additives which are or include lignosulfonates.

Testing was performed according to the following protocol. A stock solution was prepared with 4 mL of HCL in 2 L of deionized (DI) water to obtain a pH of from 1.8 to 2. Each product stock solution was prepared with 1.04 g of the product in DI water, filled to 100 mL. Ethanol (EtOH) stock solutions were prepared with 0.06 g of elemental S in 200 proof EtOH, and filled to 100 mL.

For testing of each product, first, 100 mL of acidic water in 8 oz jars in shaker set IKA KS 4000i Control shaker were preheated to 70° C. while shaking at 180 rpm. The second step was adding the desired amount of the desired product in jars. Third, 4 mL of the EtOH solution was added to all jars and blanks are recorded after 5-15 minutes of shaking at preheated temperature of 70° C. at 180 rpm. Then, percent dispersion of elemental sulfur for each sample was measured by recording final turbidity of all samples after shaking for 16 hours.

TABLE 4

| | | | | | | Sodium or | | Reducing |
|---|---|---|---|---|---|---|---|---|
| | | Total | Elemental Sulfur Dispersion | | | Ammonium | Sulfur | Sugars |
| Product | Chemistry type | solids | 30 ppm | 20 ppm | 10 ppm | content | (%) | (%) |
| 4A | Sodium | 51.33% | 72.5% | 20.8% | — | | | |
| | lignosulfonate | | | | | | | |
| 4B | Sodium | 48.99% | 40.7% | — | — | 7.1 | 7 | 4 |
| | lignosulfonate | | | | | | | |
| 4C | Sodium | | 78.4% | 49.4% | — | | | |
| | lignosulfonate | | | | | | | |
| 4D | Ammonium | 51.46% | 72% | 48.2% | — | 4.1 | 6.8 | 20 |
| | lignosulfonate | | | | | | | |
| 4E | Sodium | 29.48% | | 74.2% | 43.7% | 9* | 6* | 1* |
| | lignosulfonate | | | | | | | |
| 4F | Sodium | 48.52% | | | 74.6% | 7.1 | 7 | 3 |
| | lignosulfonate | | | | | | | |
| 4G | Sodium | 48.3% | | | 89.1% | 9 | 6 | 1 |
| | Lignosulfonate | | | | | | | |

*Product 4E is equivalent to 4G, acquired as solid and diluted to 30% solids.

### Example 5

In Example 5, elemental sulfur in acidic water prepared from DI water and HCl was tested with various dispersion additives which are or include naphthalene sulfonates.

Testing was performed according to the following protocol. A stock solution was prepared with 4 mL of HCL in 2 L of deionized (DI) water to obtain a pH of from 1.8 to 2. Each product stock solution was prepared with 1.04 g of the product in DI water, filled to 100 mL. Ethanol (EtOH) stock solutions were prepared with 0.06 g of elemental S in 200 proof EtOH, and filled to 100 mL.

For testing of each product, first, 100 mL of acidic water in 8 oz jars in shaker set IKA KS 4000i Control shaker were preheated to 70° C. and 180 rpm. The second step was adding the desired amount of the desired product in jars. Third, 4 mL of the EtOH solution was added to all jars. Blanks were recorded after 5-15 minutes of shaking at 70° C. at 180 rpm. Then, percent dispersion of elemental sulfur for each sample was measured by recording final turbidity of all results after shaking for 16 hours.

TABLE 5

| | | | | Elemental Sulfur | |
|---|---|---|---|---|---|
| | | Chemistry | Total | Dispersion | |
| | Brand | type | solids | 30 ppm | 20 ppm |
| 5A | Tamol | naphthalene | 32.3% | 69.6% | 43.4% |
| | NN9401 | sulfonate | | | |
| 5B | Tamol | naphthalene | 31.24% | 47.0% | — |
| | SN | sulfonate | | | |
| 5C | Tamol | naphthalene | 25.01% | 100.0% | 27.2% |
| | NN8906 | sulfonate | | | |

### Example 6

In Example 6, jarosite in sulfuric acidic water prepared from DI water was tested with a dispersion additive which is or includes water-soluble surfactants. Evaluations were performed by analyzing settling of the dispersion at selected intervals after mixing.

In Example 6, testing was performed according to the following protocol. A stock solution was prepared by acidifying DI water with sulfuric acid to pH of 2 or less. Then, 100 mL of the stock solution was added to 250 mL glass jars with stir bars. The jars were placed on a mixer and 25 mg of jarosite was added to each jar. Then, 25 ppm of Dowfax 2A1 as the dispersant was added to the “treated” jar. Mixing was then performed for 10 minutes at 300 rpm.

After mixing stopped, photographs were taken of the jars at selected intervals. For example, photographs may be taken hour intervals.

In Example 6, the dispersion treated with Dowfax 2A1 did not exhibit any settling of solids for at least 3 hours after mixing stopped. The dispersion formed without any dispersant exhibited settling at the one hour interval. More generally, the dispersion formed with the dispersant exhibited more dispersion stability, a trend that was persistent over time.

### Example 7

In Example 7, complex field process water from a mineral extraction plant in North America was tested with a dispersion additive including water-soluble surfactant. The complex field process water included various dissolved ions.

In Example 7, testing was performed according to the following protocol. 100 mL of the process water was added to 250 mL glass jars with stir bars and thermocoupled lids. The jars were placed in an oven preheated to 75° C. When the jars are heated to at least 65° C., the jars are removed and placed on mixer preheated to 85° C. Also, 25 mg of jarosite is added to each jar. A desired dosage of Dowfax 2A1 dispersant is then added to each “treated” jar. Mixing is performed for 10 minutes at 300 rpm. After mixing, the jars are photographed. Then all jars were returned to the oven and heated at 70° C. and let sit for 1 hour. Further photographs were taken of each jar at one hour intervals for a total of 3 hours.

In Example 7, the dispersion treated with Dowfax 2A1 did not exhibit any settling of solids at the first hour interval while the dispersion formed without any dispersant exhibited significant settling at the one hour interval. Further the dispersant most jarosite dispersed in solution with small separation.

Examples 6 and 7 illustrate that use of the dispersant provides a more stable suspension of jarosite as compared to samples that do not use the dispersant.

The data set forth above indicates that when elemental sulfur comes into contact with one of the aforementioned chemistries, it is pulled into solution and suspended or dispersed. The dispersed sulfur particles therefore give the sample solutions turbidity. The sulfur does not remain on the water's surface, deposit onto other surfaces (e.g. if stainless steel mesh coupons are suspended in the solutions or onto glass walls of the beakers) or fall out of solution. These results are unexpected and superior to what is currently known. Therefore, the data set forth above evidences that this disclosure provides an effective, inexpensive, and environmentally responsible solution for in situ treatment to minimize or prevent the deposition of sulfur on various surfaces in many industries including, but not limited to, mineral extraction, geothermal power operations and oil and gas extraction systems. In addition, this treatment is substantially low in foaming, non-corrosive, and does not interfere with other components of water treatment operations.

Moreover, the sulfur dispersion additive is typically chosen such that it is non-corrosive to the mechanical parts used in mineral extraction, geothermal, natural gas, oil, fracking, and power generation industries. Those of skill in the art understand that specific corrosion standards may change based on what equipment is in contact with the water and the sulfur dispersion additive. Any method for evaluating corrosiveness may be utilized herein. In addition, the sulfur dispersion additive is chosen such that it does not interfere with other components used in mineral extraction, geothermal, natural gas, oil, fracking, and power generation industries. These other components may include, but are not limited to, glycosides, alkyl sulphonates or alkyl amines/amides, glutaraldehyde, quaternary amines, MBT and chlorine compounds such as oxidizers, corrosion inhibitors, and the like, and combinations thereof. Typically, there are no, or minimized, side reactions between these other components and the sulfur dispersion additive, as would be understood by one of skill in the art.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. A method for dispersing complex scale based on elemental sulfur in acidic water comprising:
providing acidic water comprising elemental sulfur; and
adding from about 1 to about 100 parts by weight of a sulfur dispersion additive to the water based on one million parts by weight of the water to disperse the elemental sulfur in the water,
wherein the sulfur dispersion additive is chosen from:
a water-soluble aromatic surfactant,
a lignosulfonate,
a naphthalene sulfonate, and
combinations thereof.

2. The method of claim 1, wherein the acidic water has a pH of less than 6.5.

3. The method of claim 1, wherein the acidic water is provided at a temperature of from ambient temperature to 150° C.

4. The method of claim 1, wherein the sulfur dispersion additive is a water soluble aromatic surfactant having at least 2 aromatic rings.

5. The method of claim 1, wherein the sulfur dispersion additive is an alkyldiphenyloxide disulfonate or salt thereof.

6. The method of claim 5, wherein the alkyldiphenyloxide disulfonate or salt thereof has the following structure: 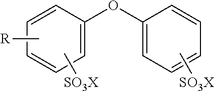
wherein R is an alkyl group having from 1 to 35 carbon atoms and each X is independently a cation.

7. The method of claim 1, wherein the sulfur dispersion additive is a lignosulfonate.

8. The method of claim 7, wherein the lignosulfonate is a sodium lignosulfonate or an ammonium lignosulfonate.

9. The method of claim 7, wherein the lignosulfonate is provided in a product having a sugar impurity content of no more than 25%, as measured by High-Performance Liquid Chromatography (HPLC).

10. The method of claim 7, wherein the lignosulfonate is provided in a product having a sulfur content of no more than 10%.

11. The method of claim 7, wherein the lignosulfonate is provided in a product having a sugar impurity content of no more than 20% and has a sulfur content of at least 5%.

12. The method of claim 7, wherein the lignosulfonate is provided in a product having a sugar impurity content of no more than 6% and has a sulfur content of at least 4%.

13. The method of claim 1, wherein the sulfur dispersion additive is a naphthalene sulfonate.

14. The method of claim 1, wherein the step of adding creates a mixture that has a turbidity of at least 10 Nephelometric Turbidity Units (NTU) in excess of a turbidity of an untreated sample of the acidic water comprising elemental sulfur without the sulfur dispersion additive.

15. A sulfur dispersing composition comprising:
acidic water;
elemental sulfur; and
a sulfur dispersion additive chosen from:
a water soluble aromatic surfactant,
a lignosulfonate,
a naphthalene sulfonate, and
combinations thereof,
wherein the sulfur dispersion additive is present in an amount of from about 1 to about 100 parts by weight per one million parts by weight of the composition.

16. The sulfur dispersing composition of claim 15, wherein the elemental sulfur is present in an amount of no more than 100 parts by weight per one million parts by weight of the water.

17. The sulfur dispersing composition of claim 15, further comprising an iron-hydroxysulfate mineral.

18. The sulfur dispersing composition of claim 15, wherein the sulfur dispersion additive is a water soluble aromatic surfactant.

19. The sulfur dispersing composition of claim 15, wherein the sulfur dispersion additive is a lignosulfonate.

20. The sulfur dispersing composition of claim 15, wherein the sulfur dispersion additive is a naphthalene sulfonate.
